(19) United States
(12) Patent Application Publication
(10) Pub. No.: US 2015/0154937 A1
(43) Pub. Date: Jun. 4, 2015

(54) COLOR SIGNAL PROCESSING CIRCUIT, COLOR SIGNAL PROCESSING METHOD, DISPLAY DEVICE, AND ELECTRONIC APPARATUS

(71) Applicant: Sony Corporation, Tokyo (JP)

(72) Inventors: Yohei Funatsu, Kanagawa (JP); Yasuo Inoue, Tokyo (JP); Tomoya Yano, Kanagawa (JP); Ryo Ogawa, Kanagawa (JP); Shoji Araki, Kanagawa (JP); Hidehisa Shimizu, Kanagawa (JP); Tetsuro Yamamoto, Kanagawa (JP); Yuki Seo, Kanagawa (JP); Takashi Uchida, Kanagawa (JP)

(73) Assignee: SONY CORPORATION, Tokyo (JP)

(21) Appl. No.: 14/407,588

(22) PCT Filed: Jun. 20, 2013
(86) PCT No.: PCT/JP2013/066954

§ 371 Date: Dec. 12, 2014

(30) Foreign Application Priority Data
Aug. 9, 2012 (JP) 2012-176850

(51) Int. Cl. G09G 5/02; G06T 5/00; G06T 11/00; G09G 3/32; G09G 5/10

(52) U.S. Cl. CPC G09G 5/026; G09G 3/3225; G09G 5/10; G06T 11/001; G06T 5/00

(57) ABSTRACT

A color signal processing circuit of the present disclosure includes: a correction signal generation unit which generates, on the basis of a signal level of a color signal corresponding to one primary color among color signals corresponding to a plurality of primary colors being input, a correction signal for chromaticity of a color signal corresponding to another primary color as a difference value from a signal level of each color signal corresponding to predetermined chromaticity; and a correction unit which uses the correction signal generated by the correction signal generation unit to correct the color signal corresponding to the other primary color.

### TECHNICAL FIELD

The present disclosure relates to a color signal processing circuit, a color signal processing method, a display device, and an electronic apparatus.

### BACKGROUND ART

In a display device such as a flat panel display device including a liquid crystal display device or an organic EL (electro luminescence) display device, a single picture element (unit pixel/pixel) that is a unit by which a color image is formed is formed of a plurality of sub-picture elements (subpixels) corresponding to different display colors. The light emission luminance of each of the plurality of subpixels changes according to a signal level of a corresponding color signal.

While the light emission luminance of the subpixel changes according to the signal level of the color signal as described above, the chromaticity changes in some cases according to the signal level due to a problem with a characteristic of a device (light-emitting device) constructing the subpixel. In order to correct the change in chromaticity according to the signal level, the chromaticity correction is conventionally implemented by adding a correction circuit using a look-up table (LUT) to a signal conversion circuit which converts color signals of three colors including R (red), G (green), and B (blue) to color signals of four colors including W (white) (refer to Patent Document 1, for example).

### CITATION LIST

### Patent Document

Patent Document 1: Published Japanese Translation of PCT Application No. 2010-524044

### SUMMARY OF THE INVENTION

### Problems to be Solved by the Invention

In the conventional art described in Patent Document 1 above, a signal indicating the intensity corresponding to RGB is generated as a correction signal on the basis of the color signal of W, and then the correction signal is subtracted from the color signals of RGB to correct the change in chromaticity as well as correct the increase in luminance accompanying the addition of the W signal. As a result, a data volume is increased in the conventional art because the output of the circuit generating the correction signal needs to cover the full range of a signal value of each primary color.

An object of the present disclosure is to provide a color signal processing circuit which can correct the change in chromaticity corresponding to the signal level of the color signal with less data volume, a color signal processing method, a display device using the color signal processing circuit, and an electronic apparatus including the display device.

### Solutions to Problems

A color signal processing circuit provided in the present disclosure to achieve the aforementioned object includes: a correction signal generation unit which generates, on the basis of a signal level of a color signal corresponding to one primary color among color signals corresponding to a plurality of primary colors being input, a correction signal for chromaticity of a color signal corresponding to another primary color as a difference value from a signal level of each color signal corresponding to predetermined chromaticity; and a correction unit which uses the correction signal generated by the correction signal generation unit to correct the color signal corresponding to the other primary color.

The color signal processing circuit of the present disclosure can be used as a color signal processing circuit included in a display device. Moreover, the display device using the color signal processing circuit of the present disclosure is suitably used as a display unit included in electronic apparatuses of various kinds.

A color signal processing method provided in the present disclosure to achieve the aforementioned object includes: generating, on the basis of a signal level of a color signal corresponding to one primary color among color signals corresponding to a plurality of primary colors being input, a correction signal for chromaticity of a color signal corresponding to another primary color as a difference value from a signal level of each color signal corresponding to predetermined chromaticity; and using the generated correction signal to correct the color signal corresponding to the other primary color.

When chromaticity of one primary color changes according to a signal level of a color signal corresponding to the one primary color, the change in chromaticity can be corrected by additive mixture of another primary color. At this time, the one primary color is a primary color to be corrected while the other primary color is a primary color used to correct the chromaticity of the one primary color. Then, when the chromaticity of the one primary color is corrected, a correction signal corresponding to a color signal of the other primary color, namely, a correction signal used to adjust a signal level of the color signal of the other primary color, is generated as a difference value from a signal level (correction target level) of each color signal corresponding to predetermined chromaticity on the basis of the signal level of the color signal corresponding to the one primary color.

Here, “predetermined luminance” refers to the chromaticity in an arbitrary gradation of the primary color to be corrected, or the aforementioned one primary color. The arbitrary gradation can be set to the maximum gradation, for example. The difference value from the signal level of each color signal corresponding to the predetermined chromaticity serves as the correction signal so that the output of the correction signal generation unit generating the correction signal need not cover the full range of a signal value of the other primary color. As a result, where the bit precision of the output value of the correction signal generation unit is the same as when the full range needs to be covered, the data volume can be reduced as compared to the case where the full range needs to be covered. Moreover, the correction can be performed in accordance with chromaticity specified by a product in addition to the predetermined temperature described above.

### Effects of the Invention

The present disclosure can reduce the data volume involved in the generation of the correction signal as compared to the case where the output of the correction signal generation unit needs to cover the full range of the signal value of the other primary color, whereby the change in chromaticity corresponding to the signal level of the color signal can be corrected with less data volume.

### BRIEF DESCRIPTION OF DRAWINGS

FIG. 1 is a block diagram illustrating the outline of a configuration of a display device using a color signal processing circuit of the present disclosure.

FIG. 2 is a block diagram illustrating an example of a configuration of the color signal processing circuit according to an embodiment of the present disclosure.

FIG. 3 is a block diagram illustrating a chromaticity change correction circuit according to first embodiment.

FIG. 4 is a block diagram illustrating a chromaticity change correction circuit according to second embodiment.

FIG. 5 is a block diagram illustrating a chromaticity change correction circuit according to variation of the second embodiment.

FIG. 6 is a block diagram illustrating a chromaticity change correction circuit according to third embodiment.

FIG. 7 is a block diagram illustrating a chromaticity change correction circuit according to fourth embodiment.

FIG. 8 is a block diagram illustrating a chromaticity change correction circuit according to fifth embodiment.

FIG. 9 is a block diagram illustrating a chromaticity change correction circuit according to sixth embodiment.

FIG. 10 is a block diagram illustrating a configuration of a conventional color signal processing circuit according to comparative example.

### MODES FOR CARRYING OUT THE INVENTION

Modes for carrying out the technology of the present disclosure (hereinafter referred to as “embodiments”) will be described in detail below with reference to the drawings. In the following description and the drawings, the same reference numeral is assigned to the same element or an element having the same function in order to omit the redundant description. Note that the description will be provided in the following order.

1. General description on color signal processing circuit and color signal processing method of present disclosure

2. Display device of present disclosure

3. Color signal processing circuit according to embodiment

3-1. First embodiment

3-2. Second embodiment

3-3. Variation of second embodiment

3-4. Third embodiment

3-5. Fourth embodiment

3-6. Fifth embodiment

3-7. Sixth embodiment

4. Comparative example

5. Variation of embodiment

6. Electronic apparatus of present disclosure

7. Configuration of present disclosure

### 1. General Description on Color Signal Processing Circuit and Color Signal Processing Method of Present Disclosure

A color signal processing circuit (color signal processing method) of the present disclosure can be used as a color signal processing circuit (color signal processing method) included in a flat-panel display device such as a liquid crystal display device or an organic EL display device. In the flat-panel display device, a single picture element (pixel) that is a unit by which a color image is formed includes a plurality of sub-picture elements (subpixels) corresponding to a different display color.

Typically, the single pixel is formed of three subpixels including a subpixel displaying a red color (Red; R), a subpixel displaying a green color (Green; G), and a subpixel displaying a blue color (Blue; B). Besides this typical pixel configuration, a pixel configuration can include a subpixel of one or a plurality of colors in addition to the subpixel of each of the three RGB primary colors. Specifically, the pixel configuration can include, for example, a subpixel displaying a white color (White; W) to enhance luminance or a subpixel displaying a yellow color (Yellow; Ye) to extend a color range.

In the display device including these pixel configurations, there is a case where chromaticity changes according to a signal level of a color signal driving a subpixel due to a problem with a characteristic of a device (light-emitting device) constructing the subpixel. This change in chromaticity can be corrected by additive mixture of another primary color, namely, a display color of another subpixel.

According to the color signal processing circuit and the color signal processing method of the present disclosure provided to realize the aforementioned chromaticity correction, there is first generated, on the basis of a signal level of a color signal corresponding to one primary color among color signals corresponding to a plurality of primary colors being input, a correction signal for the chromaticity of a color signal corresponding to another primary color as a difference value from a signal level of each color signal corresponding to predetermined chromaticity. Here, “predetermined luminance” refers to the chromaticity in an arbitrary gradation of the primary color to be corrected, or the aforementioned one primary color. The arbitrary gradation can be set to the maximum gradation, for example. The correction signal is then used to correct the color signal of the other primary color so that the processing to correct the change in chromaticity corresponding to the signal level of the color signal is implemented.

The display device including the color signal processing circuit of the present disclosure which can implement the processing of correcting the change in chromaticity can be used as a display unit (display device) of an electronic apparatus in every field which displays a picture signal input to the electronic apparatus or a picture signal generated therein as an image or a picture. The electronic apparatus can be a portable information device such as a digital camera, a video camera, a game machine, a notebook personal computer, a television system, a projection display system and an electronic book device, or a portable communication device such as a mobile phone.

In the color signal processing circuit of the present disclosure including the aforementioned preferred configuration, it is preferable that luminance expressed by the input color signal of the plurality of primary colors is identical to luminance expressed by the color signal of the other primary color and the color signal of the one primary color after correction. Being “identical” in this case means to be strictly identical as well as substantially identical where various variations generated in designing or manufacturing are tolerated.

The luminance expressed by the color signal on the input side being identical to the luminance expressed by the color signal on the output side means that a correction unit performing correction on the color signal of each of RGB corrects only the chromaticity but not the luminance. In other words, a correction signal generation unit may generate the correction signal used by the correction unit as a difference value from the signal level of each color signal corresponding to predetermined chromaticity.

Moreover, in the color signal processing circuit of the present disclosure including the aforementioned preferred configuration, the correction unit can be configured to perform processing of adding the correction signal to the color signal of the other primary color. At this time, the correction signal generation unit can be configured to generate a correction signal which corrects the increase in the luminance caused by the addition of the correction signal to the color signal of the other primary color, while the correction unit can be configured to perform processing of subtracting the correction signal generated by the correction signal generation unit from the color signal of the one primary color.

Moreover, in the color signal processing circuit of the present disclosure including the aforementioned preferred configuration, the correction signal generation unit can be configured to output the color signal of the one primary color as a signal from which the increase in the luminance caused by the addition of the correction signal to the color signal of the other primary color is subtracted.

Furthermore, in the color signal processing circuit of the present disclosure including the aforementioned preferred configuration, the plurality of primary colors can be four primary colors including the red color (R), the green color (G), the blue color (B) and the white color (W), while the color signal of the one primary color can be a color signal of the white color, for example. Here, the color signal of the white color can be a signal generated from the color signal of each of the red, green and blue colors which expresses a predetermined gradation.

Where the pixel configuration includes the four RGBW primary colors as the plurality of primary colors, the “predetermined luminance” corresponds to the chromaticity in the maximum gradation of W that is the primary color to be corrected. The change (shift) in chromaticity of a W subpixel is zero when the input color signal of W is in the maximum gradation but, when in a halftone, the chromaticity changes in accordance with the signal level of the color signal of W. This change in chromaticity is to be corrected by additive mixture of the other primary color, namely, RGB.

Here, it is preferable that the luminance expressed by the color signal of the four primary colors, namely RGBW, that is the input color signal of the plurality of primary colors is identical to the luminance expressed by the color signal of each of RGB to express the predetermined gradation, namely the color signal of each of RGB to be the base in generating W. Being “identical” in this case means to be strictly identical as well as substantially identical where various variations generated in designing or manufacturing are tolerated.

The luminance expressed by the color signal of RGBW being identical to the luminance expressed by the color signal of each of RGB to be the base in generating W means that the correction unit performing correction on the color signal of each of RGB need only correct the chromaticity but not the luminance. In other words, the correction signal generation unit may generate the correction signal used by the correction unit as the difference value from the signal level of each color signal corresponding to the predetermined chromaticity.

Preceding the color signal processing circuit of the present disclosure, there can be provided a signal conversion unit which converts the color signal of the three RGBW primary colors into the color signal of the four primary colors including W on the basis of the color signal of the three primary colors. Here, it is preferable that the signal conversion unit is configured to set the luminance expressed by the color signal of the four primary colors after conversion to be identical to the luminance expressed by the color signal of the three primary colors before conversion. Being “identical” in this case means to be strictly identical as well as substantially identical where various variations generated in designing or manufacturing are tolerated.

In the signal conversion unit, as described above, the luminance expressed by the color signal of the four primary colors after conversion, namely the color signal of the four primary colors input to the color signal processing circuit of the present disclosure, is identical to the luminance expressed by the color signal of the three primary colors before conversion, meaning that the correction unit performing correction on the color signal of each of RGB need only correct the chromaticity but not the luminance. In other words, the correction signal generation unit may generate the correction signal used by the correction unit as the difference value from the signal level of each color signal corresponding to the predetermined chromaticity.

Moreover, in the color signal processing circuit of the present disclosure including the aforementioned preferred configuration, the correction signal generation unit can be configured to generate the correction signal in accordance with temporal characteristic degradation of a display panel which is driven by the color signal of the other primary color after correction and the color signal of the one primary color. Alternatively, the correction signal generation unit can be configured to generate the correction signal in accordance with the temperature of the display panel. The correction signal generation unit can also be configured to generate the correction signal in accordance with a coordinate within the plane of the display panel.

Furthermore, in the color signal processing circuit of the present disclosure including the aforementioned preferred configuration, the correction signal generation unit can be formed of a look up table (LUT) in which the correction signal for the color signal of the other primary color is stored in association with the signal level of the color signal of the one primary color. While it may be configured to include one look up table, it is preferable to include a plurality of look up tables in accordance with the change in chromaticity caused by the temporal characteristic degradation of the display panel which is driven by the color signal of the other primary color after correction and the color signal of the one primary color, so that one table may be selected for use as deemed appropriate.

In providing the plurality of look up tables, it can be configured to provide the plurality of look up tables in accordance with the change in chromaticity caused by the temporal characteristic degradation of the display panel so that one of the tables is selected for use according to the degree of the temporal characteristic degradation of the display panel. Alternatively, it can be configured to provide the plurality of look up tables in accordance with the change in chromaticity caused by the temperature of the display panel so that one of the tables is selected for use according to a detected temperature of the display panel. It can also be configured to provide the plurality of look up tables in accordance with the change in chromaticity within the plane of the display panel so that one of the tables is selected for use according to the coordinate within the plane of the display panel.

Furthermore, in the color signal processing circuit of the present disclosure including the aforementioned preferred configuration, the correction signal generation unit can be configured to have a first conversion function, a second conversion function, and a subtraction function. The first conversion function is a function which converts the signal level of the color signal of the one primary color into the signal level of the color signal of the other primary color on the basis of a characteristic between the gradation and an XYZ value in an XYZ coordinate system, such as a linear characteristic, that gives the predetermined chromaticity. Note that the characteristic of the gradation-XYZ value in the first conversion function is preferably the linear characteristic but does not have to be the linear characteristic.

The second conversion function is a function which converts the signal level of the color signal of the one primary color into the signal level of the color signal of the other primary color on the basis of a non-linear characteristic between the gradation and an XYZ value in the XYZ coordinate system which gives the actual chromaticity expressed by the color signal of the plurality of primary colors. Here, the “actual chromaticity” corresponds to the chromaticity that is actually expressed under the characteristic of a device of each subpixel when the corresponding subpixel is driven by the color signal of the plurality of primary colors. The subtraction function is a function which finds a difference between the signal level converted by the first conversion function and the signal level converted by the second conversion function.

The first conversion function, the second conversion function, and the subtraction function can be configured by hardware or executed by using a microcomputer. Moreover, the look up table described above stores the correction signal for the color signal of the other primary color which is obtained under these functions and corresponds to the signal level of the one primary color signal.

Now, the color signal processing circuit (color signal processing method) of the present disclosure, the display device (display device of the present disclosure) using the color signal processing circuit, and the electronic apparatus (electronic apparatus of the present disclosure) including the display device will be described more specifically. Note that various conditions illustrated in the present description are satisfied when strictly established as well as when substantially established. Various variations generated in designing or manufacturing are tolerated.

### 2. Display Device of Present Disclosure

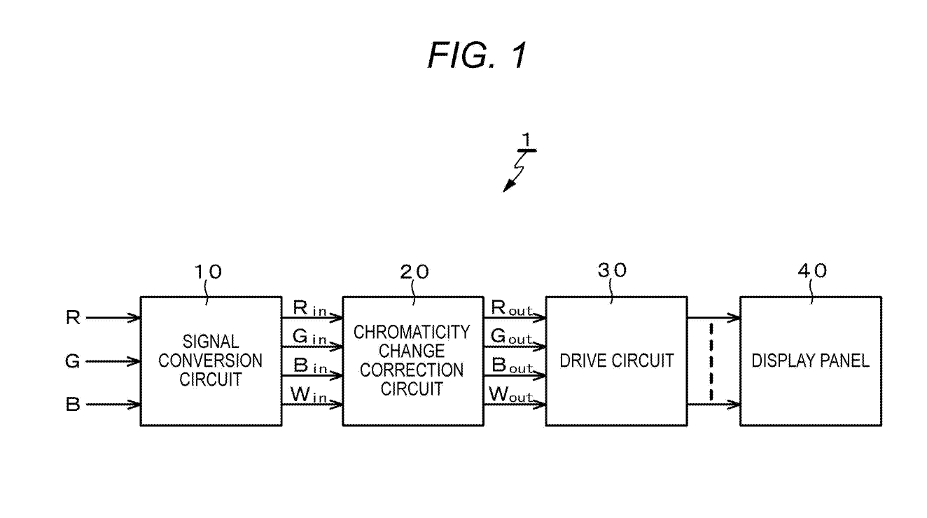

First, the display device using the color signal processing circuit of the present disclosure, namely the display device of the present disclosure, will be described with reference to FIG. 1.

FIG. 1 is a block diagram illustrating the outline of a configuration of the display device using the color signal processing circuit of the present disclosure. As illustrated in FIG. 1, a display device 1 of the present disclosure includes a signal conversion circuit 10, a chromaticity change correction circuit 20, a drive circuit 30, and a display panel 40 and has a configuration where color signals RGB of the three primary colors including the red color (R), the green color (G) and the blue color (B) are input.

The signal conversion circuit 10 performs processing of converting the color signal of the three primary colors expressing a predetermined gradation into the color signal of the four primary colors including the white color (W) on the basis of the color signal of the three primary colors. In the signal conversion, the signal conversion circuit 10 performs the signal processing such that the luminance expressed by the color signal of the four primary colors after conversion becomes identical to the luminance expressed by the color signal of the three primary colors before conversion. A specific configuration will be described later on. Color signals Rᵢₙ, Gᵢₙ, Bᵢₙ, and Wᵢₙ of the four primary colors converted in the signal conversion circuit 10 are input to the chromaticity change correction circuit 20.

The chromaticity change correction circuit 20 determines one of the four primary colors, such as the white color, as the primary color to be corrected and another primary color as the primary color used to correct the chromaticity of the white color, and performs processing of correcting the change in chromaticity of the white color. The color signal processing circuit of the present disclosure to be described later can be used as the chromaticity change correction circuit 20.

The display panel 40 is a known flat panel such as a liquid crystal panel or an organic EL panel, is formed by arranging pixels (subpixels) including a light-emitting device into a two-dimensional matrix, and has a configuration where a control line such as a signal line or a scanning line is wired in a matrix against the matrix-like pixel arrangement.

The drive circuit 30 drives the display panel 40 to perform display. Specifically, the drive circuit 30 performs processing of supplying color signals Rₒᵤₜ, Gₒᵤₜ, Bₒᵤₜ, and Wₒᵤₜ of the four primary colors, the chromaticity of which are corrected in the chromaticity change correction circuit 20, to the signal line wired for each pixel row on the display panel 40 in synchronization with vertical scanning by a scanning unit that is not shown.

### 3. Color Signal Processing Circuit According to Embodiment

Next, there will be described specifically the color signal processing circuit according to an embodiment of the present disclosure that is used as the chromaticity change correction circuit 20 of the display device 1 having the aforementioned configuration.

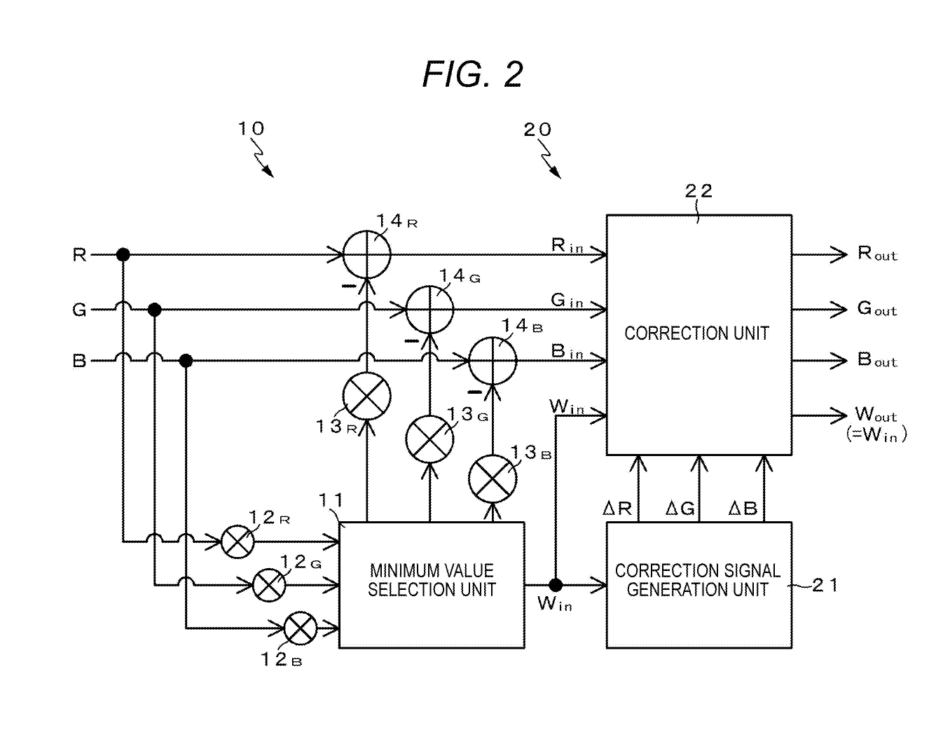

FIG. 2 is a block diagram illustrating an example of a configuration of the color signal processing circuit according to an embodiment of the present disclosure. Here, the color signal processing circuit according to an embodiment is illustrated as the chromaticity change correction circuit 20 along with a specific example of a configuration of the signal conversion circuit 10.

(Signal Conversion Circuit)

First, the signal conversion circuit 10 includes a minimum value selection unit 11, multipliers 12_{R}, 12_{G}, and 12_{B} on the input side thereof, and multipliers 13_{R}, 13_{G}, and 13_{B} as well as subtracters 14_{R}, 14_{G}, and 14_{B} on the output side of the minimum value selection unit.

In the signal conversion circuit 10, the color signals R, G, and B of the three primary colors including red, green and blue colors expressing a predetermined gradation are supplied to the multipliers 12_{R}, 12_{G}, and 12_{B} and the subtracters 14_{R}, 14_{G}, and 14_{B}. The multipliers 12_{R}, 12_{G}, and 12_{B} multiply the color signals R, G, and B of the three primary colors by a predetermined coefficient and supply the multiplication result to the minimum value selection unit 11.

The minimum value selection unit 11 performs processing of selecting the color signal having the minimum value from among the color signals R, G, and B of the three primary colors multiplied by the predetermined coefficient and supplied from the multipliers 12_{R}, 12_{G}, and 12_{B}. The minimum value selection unit 11 outputs the selected color signal having the minimum value as the color signal of the white color (W) and supplies the signal to the multipliers 13_{R}, 13_{G}, and 13_{B}.

The multipliers 13_{R}, 13_{G}, and 13_{B} multiply the color signal having the minimum value selected by the minimum value selection unit 11 by a predetermined coefficient and supply the signal to the subtracters 14_{R}, 14_{G}, and 14_{B}. The multipliers 13_{R}, 13_{G}, and 13_{B} use a coefficient similar to a reciprocal of the coefficient used by the multipliers 12_{R}, 12_{G}, and 12_{B} as the predetermined coefficient, for example.

The subtracters 14_{R}, 14_{G}, and 14_{B} perform processing of subtracting the output signal of the multipliers 13_{R}, 13_{G}, and 13_{B} from the color signals R, G, and B of the three primary colors and supply the color signals of the four primary colors including the color signal W output from the minimum value selection unit 11 to the chromaticity change correction circuit 20.

In converting the color signals R, G, and B of the three primary colors into the color signals R, G, B, and W of the four primary colors including the white color, the signal conversion circuit 10 having the aforementioned configuration performs signal processing such that the luminance expressed by the color signals R, G, B, and W of the four primary colors after conversion is identical to the luminance expressed by the color signals of the three primary colors R, G, and B before conversion. This signal processing is implemented by the action of the multipliers 12_{R}, 12_{G}, and 12_{B}, the multipliers 13_{R}, 13_{G}, and 13_{B}, and the subtracters 14_{R}, 14_{G}, and 14_{B}.

Note that the configuration of the signal conversion circuit 10 is merely illustrated as an example, where the configuration of the signal conversion circuit 10 is not limited to the configuration illustrated herein. In other words, the signal conversion circuit 10 may have any configuration as long as the circuit is adapted to perform the signal processing such that the luminance expressed by the color signals R, G, B, and W of the four primary colors after conversion is identical to the luminance expressed by the color signals of the three primary colors R, G, and B before conversion.

(Chromaticity change correction circuit) As illustrated in FIG. 2, the chromaticity change correction circuit 20 that is the color signal processing circuit according to an embodiment of the present disclosure includes a correction signal generation unit 21 and a correction unit 22 and has a configuration to which the color signals R, G, B, and W of the four primary colors are input from the signal conversion circuit 10 in the preceding stage. Here, the luminance expressed by the input color signals R, G, B, and W of the four primary colors is identical to the luminance expressed by the color signals R, G, and B of the three primary colors expressing a predetermined gradation.

The correction signal generation unit 21 performs processing of generating correction signals ΔR, ΔG, and ΔB for the chromaticity of the color signal of the other primary color as a difference value from the signal level of each color signal corresponding to predetermined chromaticity, on the basis of the signal level of the color signal of the one primary color among input color signals Rᵢₙ, Gᵢₙ, Bᵢₙ, and Wᵢₙ of the four primary colors.

Here, as an example, it is assumed that the chromaticity of the white color changes according to the signal level (intensity) of the color signal W of the white color. In this case, the change in chromaticity of the white color is to be corrected by additive mixture of the other primary color, namely, the red, green, and blue colors. The “predetermined chromaticity” in this case corresponds to the chromaticity in the maximum gradation of the white color that is the primary color to be corrected.

Moreover, in the aforementioned example, the white color is the primary color to be corrected while the red, green, and blue colors are the primary colors used to correct the chromaticity of the white color. The primary color used to correct the chromaticity need not be within the same pixel as the primary color to be corrected but, for example, one can use the primary color in a pixel adjacent or close to the pixel in which the primary color to be corrected is located.

The correction unit 22 performs processing of correcting the change in chromaticity of the white color by using the correction signals ΔR, ΔG, and ΔB generated by the correction signal generation unit 21 and correcting (adjusting) the color signals Rᵢₙ, Gᵢₙ, and Bᵢₙ of the other primary color. The correction unit 22 corrects only the change in chromaticity by using the correction signals ΔR, ΔG, and ΔB that is the difference value. As a result, the luminance expressed by the color signals Rᵢₙ, Gᵢₙ, Bᵢₙ, and Wᵢₙ of the four primary colors is identical to the luminance expressed by color signals Rₒᵤₜ, Gₒᵤₜ, and Bₒᵤₜ of the other primary colors and a color the correction unit 22.

As described above, in the chromaticity change correction circuit 20 having the aforementioned configuration, the luminance expressed by the input color signals R, G, B, and W of the four primary colors is identical to the luminance expressed by the color signals R, G, and B of the three primary colors expressing the predetermined gradation, whereby the correction unit 22 need only correct the chromaticity. The correction signal generation unit 21 thus generates the correction signals ΔR, ΔG, and ΔB as the difference value from the color signal Wᵢₙ corresponding to the chromaticity in the maximum gradation of the white color that is the primary color to be corrected, so that the output from the correction signal generation unit 21 need not cover the full range of the signal value of the color signals Rᵢₙ, Gᵢₙ, and Bᵢₙ

As a result, where the bit precision of the output value of the correction signal generation unit 21 is the same as when the full range needs to be covered, there can be reduced the data volume as compared to the case where the full range needs to be covered. The change in chromaticity corresponding to the signal level of the color signal Wᵢₙ of the white color can thus be corrected with less data volume. Moreover, the chromaticity can be corrected in accordance with the chromaticity specified by the product.

The correction signal generation unit 21 can also be configured to generate a value of the correction signals ΔR, ΔG, and ΔB according to the temporal characteristic degradation of the display panel 40, more specifically, the temporal characteristic degradation of a light-emitting device of the subpixel. Moreover, the correction signal generation unit can be configured to generate the value of the correction signals ΔR, ΔG, and ΔB according to a temperature of the display panel 40 or a coordinate within the plane of the display panel 40. In addition, the correction signal generation unit can be configured to generate the value of the correction signals ΔR, ΔG, and ΔB according to a condition of driving the display panel 40 such as a drive voltage, a drive frequency or a light emission duty.

Such configuration allows one to use the correction signals ΔR, ΔG, and ΔB to correct not only the initial change in chromaticity but also the temporal change in chromaticity as well as a change in chromaticity caused by a change in the condition to drive the display panel 40.

The correction signal generation unit 21, which generates the correction signals ΔR, ΔG, and ΔB as the difference value from the signal level of the color signal Wᵢₙ corresponding to the chromaticity in the maximum gradation of the white color that is the primary color to be corrected, can be realized by including the first conversion function, the second conversion function, and the subtraction function. The first conversion function is the function which converts the signal level of the color signal Wᵢₙ of the white color into the signal level of the color signals Rᵢₙ, Gᵢₙ, and Bᵢₙ of the other primary colors on the basis of the characteristic of the gradation-XYZ value, preferably a linear characteristic, which gives the chromaticity in the maximum gradation of the white color that is the primary color to be corrected. Here, the XYZ value is a value indicating the luminance and chromaticity in the XYZ coordinate system.

The second conversion function is the function which converts the signal level of the color signal Wᵢₙ of the white color into the signal level of the color signals Rᵢₙ, Gᵢₙ, and Bᵢₙ of the other primary colors on the basis of the non-linear characteristic of the gradation-XYZ value which gives the actual chromaticity expressed by the color signals Rᵢₙ, Gᵢₙ, Bᵢₙ, and Wᵢₙ of the four primary colors. Here, the “actual chromaticity” corresponds to the chromaticity that is actually expressed under the characteristic of the device of each subpixel when the corresponding subpixel is driven by the color signals Rₒᵤₜ, Gₒᵤₜ, Bₒᵤₜ, and Wₒᵤₜ of the four primary colors.

The subtraction function is the function which finds the difference between the signal level converted by the first conversion function and the signal level converted by the second conversion function. By executing the first conversion function, the second conversion function, and the subtraction function, the correction signals ΔR, ΔG, and ΔB can be generated as the difference value from the signal level of the color signal Wᵢₙ corresponding to the predetermined chromaticity, namely, the chromaticity in the maximum gradation of the white color.

The first conversion function, the second conversion function, and the subtraction function can be configured by hardware or executed by software while using a microcomputer. Moreover, it can be adapted to use the look up table in which the correction signals ΔR, ΔG, and ΔB found by executing the first conversion function, the second conversion function, and the subtraction function are stored in association with the signal level of the color signal Wᵢₙ of the white color. There will now be described a specific embodiment of the chromaticity change correction circuit 20 that is the color signal processing circuit according to an embodiment of the present disclosure.

### 3-1. First Embodiment

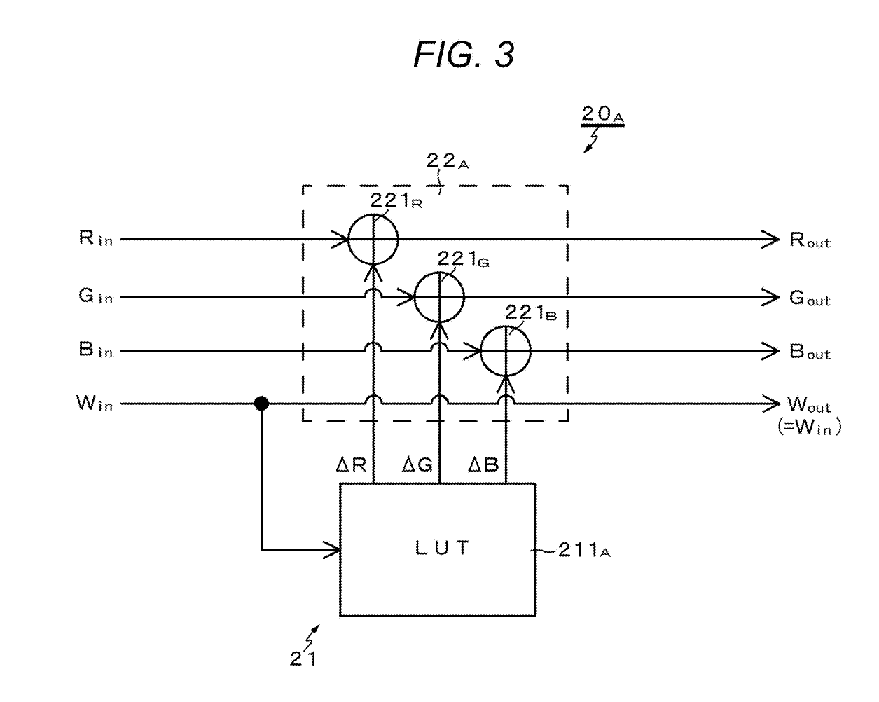

FIG. 3 is a block diagram illustrating a chromaticity change correction circuit (that is, a color signal processing circuit) according to first embodiment.

A chromaticity change correction circuit 20_{A} according to the first embodiment is configured to use a look up table (LUT) 211_{A} as a correction signal generation unit 21. The look up table 211_{A} stores in advance the correction signals ΔR, ΔG, and ΔB found by executing the aforementioned first conversion function, the second conversion function, and the subtraction function in association with the signal level of the color signal Wᵢₙ of the white color. The correction signals ΔR, ΔG, and ΔB may take either a positive or negative value.

When the color signal Wᵢₙ of the white color is input to the look up table 211_{A}, the correction signals ΔR, ΔG, and ΔB corresponding to the signal level of the color signal Wᵢₙ of the white color are output from the look up table 211_{A} and then input to a correction unit 22_{A}. The correction unit 22_{A} includes adder/subtracters 221_{R}, 221_{G}, and 221_{B} corresponding to color signals Rᵢₙ, Gᵢₙ, and Bᵢₙ and performs processing to add or subtract the correction signals ΔR, ΔG, and ΔB to/from the signal level of the color signals Rᵢₙ, Gᵢₙ, and Bᵢₙ.

As a result, the correction unit 22_{A} outputs the color signals Rₒᵤₜ, Gₒᵤₜ, and Bₒᵤₜ of the three primary colors to realize light emission of a subpixel of the white color, the chromaticity of which is corrected, along with a color signal Wₒᵤₜ of the white color. Note that no processing is performed on the color signal Wₒᵤₜ of the white color, or Wₒᵤₜ=Wᵢₙ.

As is apparent from the description of the action and effect of the embodiment, the data volume of the correction signal generation unit 21 can be reduced in the chromaticity change correction circuit 20_{A} according to the first embodiment, whereby the look up table used as the correction signal generation unit 21 can be scaled down. Similar action and effect are obtained in second to fifth embodiments in which the look up table is used as the correction signal generation unit 21.

Note that while the correction signals ΔR, ΔG, and ΔB output from the look up table 211_{A} may take either a positive or negative value in the first embodiment, there is a case where it is preferable to permit only a positive value in terms of optimization or the like performed with respect to another signal processing block. The second embodiment has been made in consideration of this point.

### 3-2. Second Embodiment

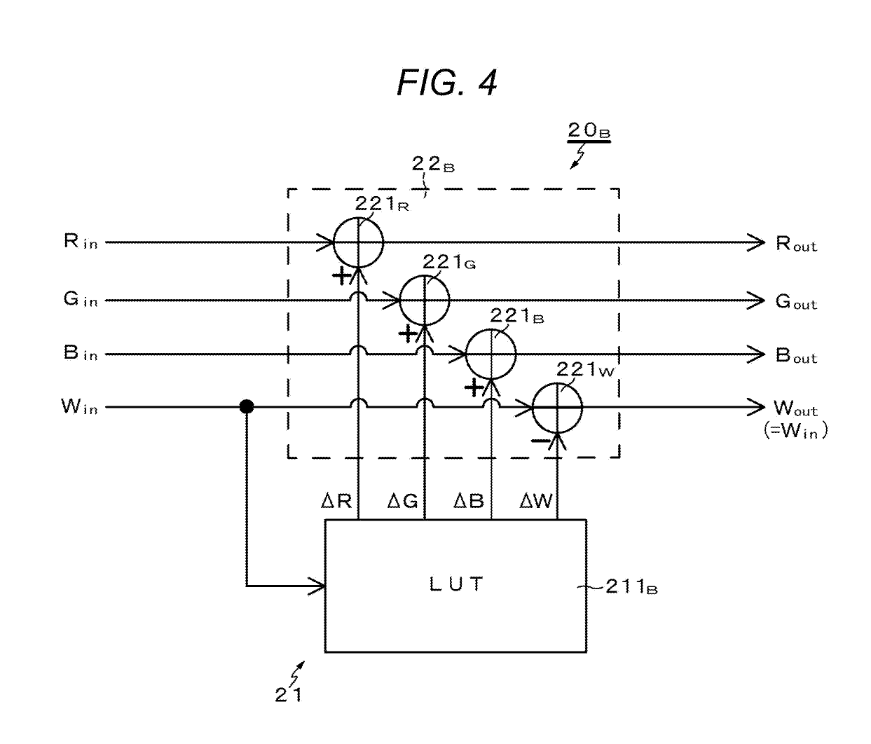

FIG. 4 is a block diagram illustrating a chromaticity change correction circuit (that is, a color signal processing circuit) according to second embodiment.

A chromaticity change correction circuit 20_{B} according to the second embodiment specifies correction signals ΔR, ΔG, and ΔB output from a look up table 211_{B} to take a positive value. Accordingly, adders 221_{R}, 221_{G}, and 221_{B} of a correction unit 22_{B} only perform addition processing.

However, it is concerned that the light emission luminance of a pixel increases as a result of addition of the correction signals ΔR, ΔG, and ΔB to color signals Rₒᵤₜ, Gₒᵤₜ, and Bₒᵤₜ of the three primary colors when the value of the correction signals ΔR, ΔG, and ΔB output from the look up table 211_{A} is restricted to take only the positive value.

In order to prevent the increase in the light emission luminance caused by the addition of the correction signals ΔR, ΔG, and ΔB to the color signals Rₒᵤₜ, Gₒᵤₜ and Bₒᵤₜ, the chromaticity change correction circuit 20_{B} according to the second embodiment is configured to generate a correction signal ΔW for a color signal Wᵢₙ of the white color to correct the increase in the luminance caused by the addition of the correction signals ΔR, ΔG, and ΔB to color signals Rᵢₙ, Gᵢₙ, and Bᵢₙ of the three primary colors.

As with the other correction signals ΔR, ΔG, and ΔB, the correction signal ΔW for the color signal Wᵢₙ of the white color is stored in association with a signal level of the color signal Wᵢₙ of the white color in the look up table 211_{B}. The correction signal ΔW output from the look up table 211_{B} is then subtracted from the signal level of the color signal Wᵢₙ of the white color in an adder 224 of the correction unit 22_{B}.

When it is configured to add the correction signals ΔR, ΔG, and ΔB to the color signals Rₒᵤₜ, Gₒᵤₜ, and Bₒᵤₜ as described above, the correction signal ΔW is subtracted from the signal level of the color signal Wᵢₙ of the white color to be able to prevent the light emission luminance of the pixel from increasing by the addition of the correction signals ΔR, ΔG, and ΔB.

### 3-3. Variation of Second Embodiment

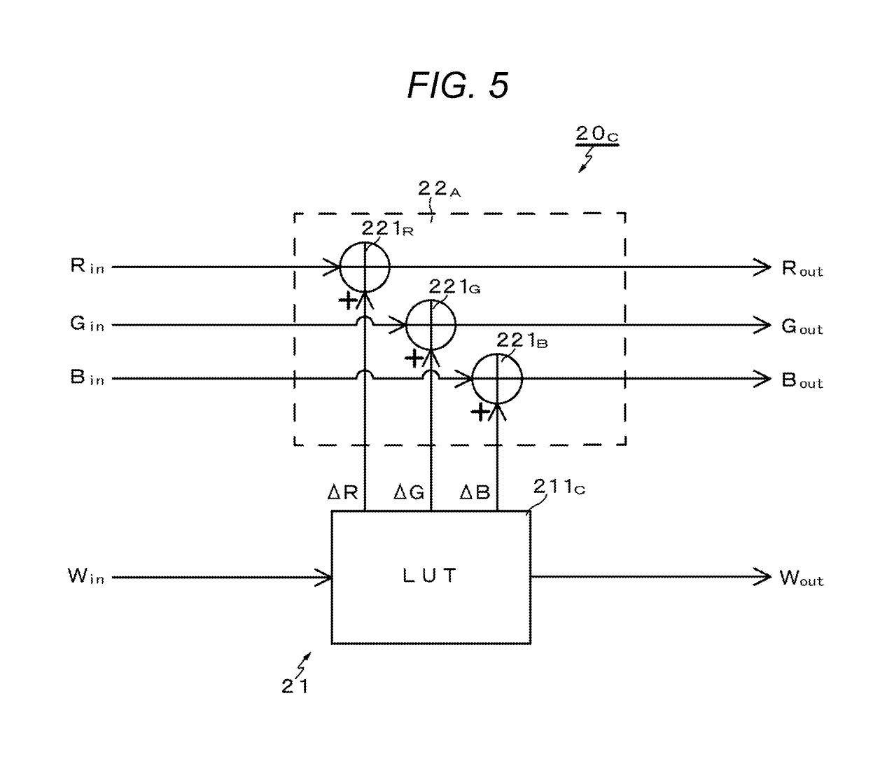

FIG. 5 is a block diagram illustrating a chromaticity change correction circuit (that is, a color signal processing circuit) according to a variation of the second embodiment.

In the second embodiment, the correction signal ΔW for the color signal Wᵢₙ of the white color is stored in the look up table 211_{B} so that the correction signal ΔW output from the look up table 211_{B} is subtracted from the signal level of the color signal Wᵢₙ of the white color, thereby achieving the anticipated object.

On the other hand, a chromaticity change correction circuit 20_{C} according to the present variation is configured to store in advance the color signal Wᵢₙ of the white color into a look up table 211_{C} as a signal from which the increase in the luminance caused by the addition of the correction signals ΔR, ΔG, and ΔB to the color signals Rₒᵤₜ, Gₒᵤₜ and Bₒᵤₜ of the other primary colors is subtracted.

That is, the look up table 211_{C} stores the correction signals ΔR, ΔG, and ΔB as well as a color signal Wₒᵤₜ of the white color taking into consideration the increase in the luminance caused by the addition of the correction signals ΔR, ΔG, and ΔB. When the color signal Wᵢₙ of the white color is input, the correction signals ΔR, ΔG, and ΔB corresponding to the signal level of the color signal Wᵢₙ as well as the color signal Wₒᵤₜ of the white color which suppresses the increase in the luminance caused by the addition of the correction signals ΔR, ΔG, and ΔB are output from the look up table

In the variation of the second embodiment where the color signal Wₒᵤₜ stored in the look up table 211_{C} is not a difference value, the action and effect equivalent to the second embodiment can still be obtained though the data volume in the look up table 211_{C} increases compared to the second embodiment.

### 3-4. Third Embodiment

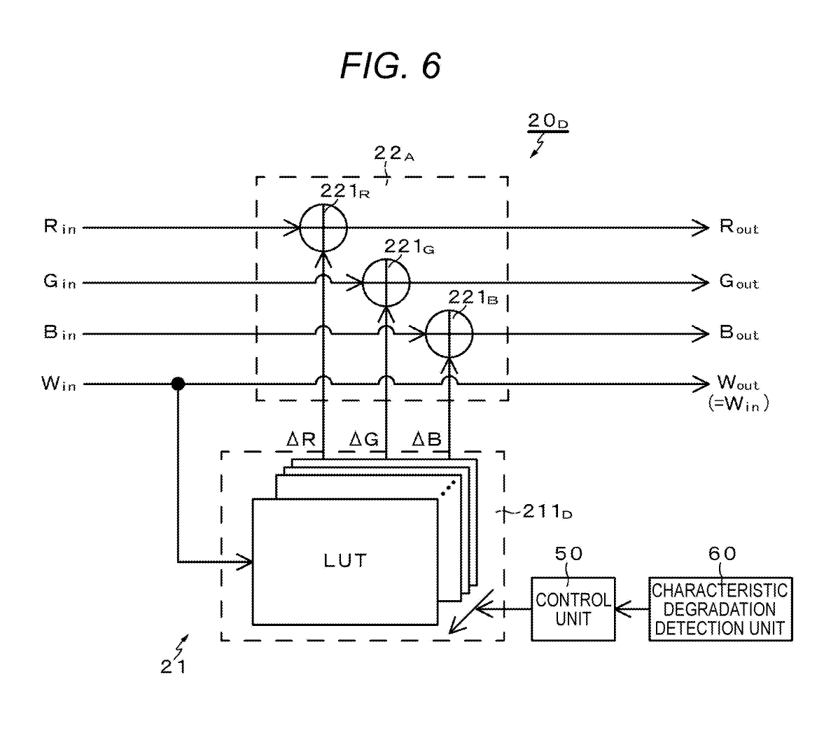

FIG. 6 is a block diagram illustrating a chromaticity change correction circuit (that is, a color signal processing circuit) according to third embodiment.

A chromaticity change correction circuit 20_{D} according to the third embodiment is based on the configuration of the chromaticity change correction circuit 20_{A} according to the first embodiment and is configured to use a plurality of look up tables as a look up table 211_{D}. The look up table 211_{D} is formed of the plurality of look up tables as well in fourth and fifth embodiments to be described later. This can also be applied to a case where the chromaticity change correction circuit 20_{D} is based on the configuration of the chromaticity change correction circuit 20_{B} according to the second embodiment or the chromaticity change correction circuit 20_{C} according to the variation of the second embodiment.

Where the plurality of look up tables is used as the look up table 211_{D}, the chromaticity change correction circuit 20_{D} according to the third embodiment is adapted to store, in the plurality of look up tables, a value corresponding to the temporal characteristic degradation of a display panel 40 as correction signals ΔR, ΔG, and ΔB. The temporal characteristic degradation of the display panel 40 can be temporal characteristic degradation of a light-emitting device (such as an organic EL device) of a subpixel, for example.

The chromaticity change correction circuit 20_{D} according to the third embodiment is configured to include a control unit 50 and a characteristic degradation detection unit 60 in addition to a correction signal generation unit 21 and a correction unit 22. The control unit 50 performs control to select one of the plurality of look up tables included in the look up table 211_{D} on the basis of a detected signal from the characteristic degradation detection unit 60.

The characteristic degradation detection unit 60 detects the temporal characteristic degradation of the display panel 40 and supplies the detected signal corresponding to the degree of that characteristic degradation to the control unit 50. The temporal characteristic degradation of the display panel 40 can be detected on the basis of a cumulative lit time of the display panel 40 or a degradation state of the pixel. The degradation state of the pixel can be detected by storing and holding as information a lit time and a display gradation (signal intensity) of an individual pixel for an arbitrary pixel or a pixel in an arbitrary region, for example.

According to the chromaticity change correction circuit 20_{D} of the third embodiment having the aforementioned configuration, the correction signals ΔR, ΔG, and ΔB can be used to correct the initial change in chromaticity as well as the optimal one of the correction signals ΔR, ΔG, and ΔB can be used to correct the temporal change in chromaticity. As a result, the change in chromaticity can be corrected more certainly regardless of the degree of the temporal characteristic degradation of the display panel 40.

### 3-5. Fourth Embodiment

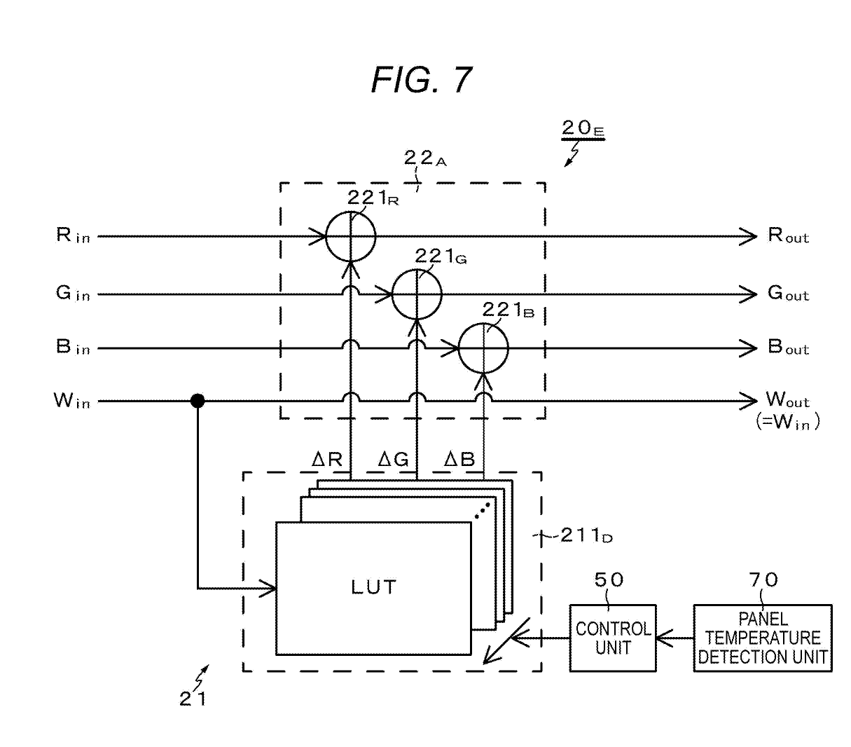

FIG. 7 is a block diagram illustrating a chromaticity change correction circuit (that is, a color signal processing circuit) according to fourth embodiment.

As with the chromaticity change correction circuit 20_{D} according to the third embodiment, a chromaticity change correction circuit 20_{E} according to the fourth embodiment is configured to use the plurality of look up tables as the look up table 211_{D}. The chromaticity change correction circuit 20_{E} according to the fourth embodiment is configured to include a control unit 50 and a panel temperature detection unit 70 in addition to a correction signal generation unit 21 and a correction unit 22.

The chromaticity changes in accordance with a signal level but also in accordance with the temperature of a display panel 40 in some cases. Where the plurality of look up tables is used as the look up table 211_{D}, the chromaticity change correction circuit 20_{E} according to the fourth embodiment is adapted to store, in the plurality of look up tables, a value corresponding to the temperature of the display panel 40 as correction signals ΔR, ΔG, and ΔB.

The panel temperature detection unit 70 detects the temperature (panel temperature) of the display panel 40 by using a temperature sensor such as a thermister. The control unit 50 performs control to select one of the plurality of look up tables included in the look up table 211_{D} on the basis of a detected signal (detected temperature) from the panel temperature detection unit 70.

According to the chromaticity change correction circuit 20_{E} of the fourth embodiment having the aforementioned configuration, the correction signals ΔR, ΔG, and ΔB can be used to correct the initial change in chromaticity as well as the optimal one of the correction signals ΔR, ΔG, and ΔB can be used to correct the change in chromaticity corresponding to the temperature of the display panel 40. As a result, the change in chromaticity can be corrected more certainly without the influence of the temperature of the display panel 40.

### 3-6. Fifth Embodiment

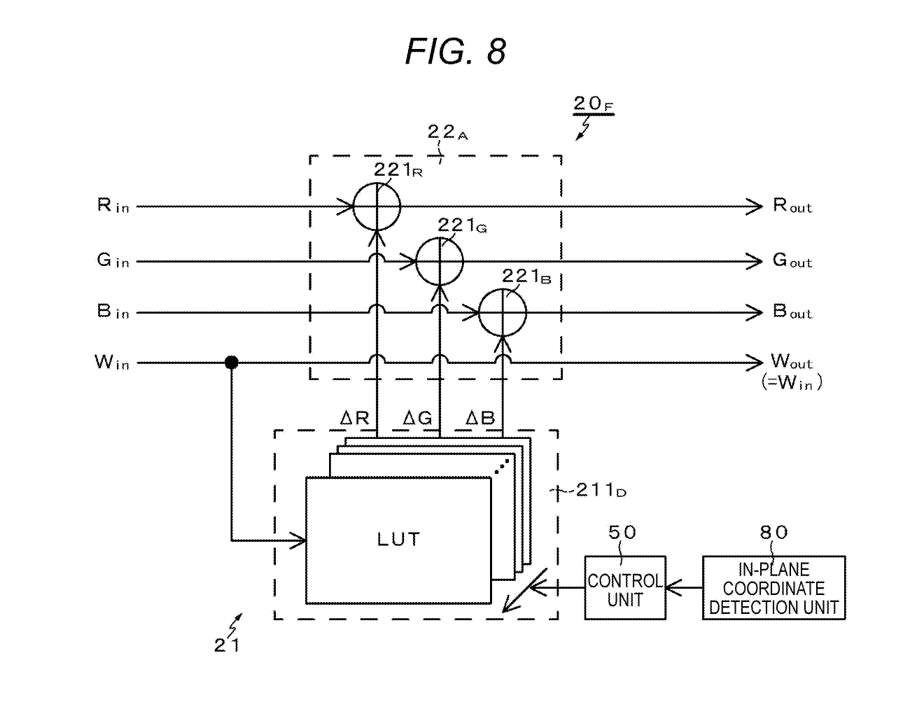

FIG. 8 is a block diagram illustrating a chromaticity change correction circuit (that is, a color signal processing circuit) according to fifth embodiment.

As with the chromaticity change correction circuit 20_{D} according to the third embodiment, a chromaticity change correction circuit 20_{F} according to the fifth embodiment is configured to use the plurality of look up tables as the look up table 211_{D}. The chromaticity change correction circuit 20_{F} according to the fifth embodiment is configured to include a control unit 50 and an in-plane coordinate detection unit 80 in addition to a correction signal generation unit 21 and a correction unit 22.

It is presupposed in the aforementioned first to fourth embodiments that the change in chromaticity is corrected across the screen. In the fifth embodiment, on the other hand, the correction processing is performed partially within the screen or performed for each pixel.

The chromaticity changes in accordance with a signal level but also in accordance with a coordinate (display location) in the plane of a display panel 40 in some cases. Where the plurality of look up tables is used as the look up table 211_{D}, the chromaticity change correction circuit 20_{F} according to the fifth embodiment is adapted to store, in the plurality of look up tables, a value corresponding to the coordinate within the plane of the display panel 40 as correction signals ΔR, ΔG, and ΔB.

On the other hand, the in-plane coordinate detection unit 80 detects a coordinate identifying an area location when partially correcting the chromaticity by dividing the screen of the display panel 40 into some areas and, when correcting the chromaticity for each pixel, detects a coordinate identifying a location of the pixel. These coordinates within the plane can be detected from address information or the like provided in driving the display. The control unit 50 performs control to select one of the plurality of look up tables included in the look up table 211_{D} on the basis of a detected signal (detected coordinate) from the in-plane coordinate detection unit 80.

According to the chromaticity change correction circuit 20_{F} of the fifth embodiment having the aforementioned configuration, the correction signals ΔR, ΔG, and ΔB can be used to correct the initial change in chromaticity as well as the optimal one of the correction signals ΔR, ΔG, and ΔB can be used to correct the change in chromaticity corresponding to the coordinate within the plane on the display panel 40. As a result, the change in chromaticity can be corrected more certainly regardless of the coordinate within the plane of the display panel 40 and, at the same time, color unevenness partially generated within the screen can be corrected.

It can be configured to use the aforementioned third to fifth embodiments individually or combine these embodiments at will for use.

### 3-7. Sixth Embodiment

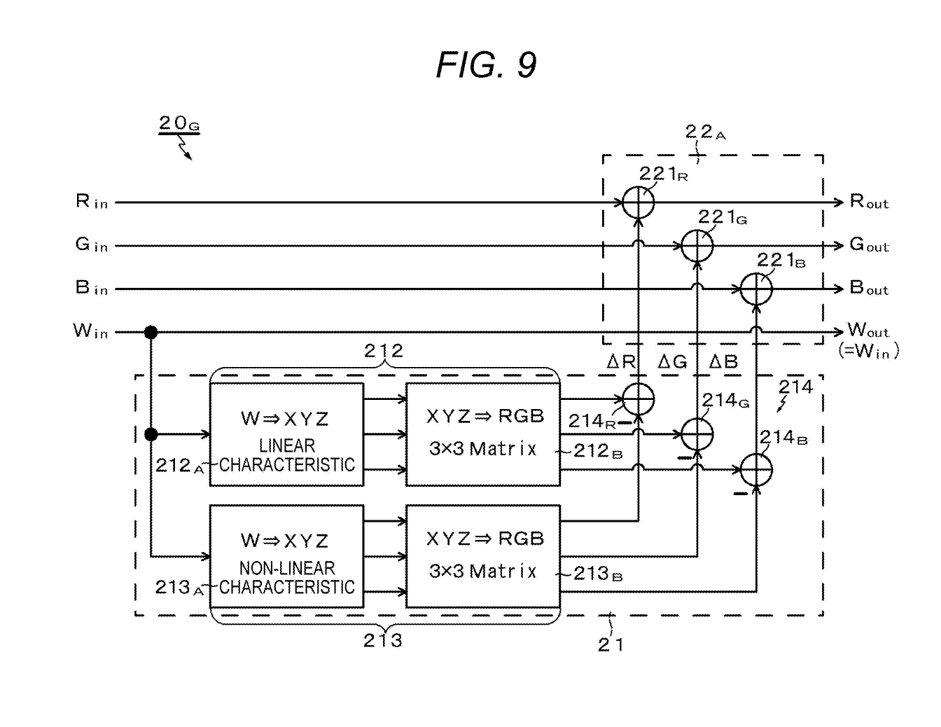

FIG. 9 is a block diagram illustrating a chromaticity change correction circuit (that is, a color signal processing circuit) according to sixth embodiment.

The aforementioned first to fifth embodiments use the look up table as a correction signal generation unit 21. On the other hand, in a chromaticity change correction circuit 20_{G} according to the sixth embodiment, the correction signal generation unit 21 is configured by hardware. That is, as illustrated in FIG. 9, the correction signal generation unit 21 includes a first conversion unit 212, a second conversion unit 213, and a subtraction unit 214.

The first conversion unit 212 converts a signal level of a color signal Wᵢₙ corresponding to a white color into signal level of color signals Rᵢₙ, Gᵢₙ, and Bᵢₙ of other primary colors on the basis of a characteristic of a gradation-XYZ value which gives the chromaticity in the maximum gradation of the white color that is the primary color to be corrected. The characteristic of the gradation-XYZ value used here is preferably a linear characteristic but is not limited thereto.

More specifically, assuming that the gradation-XYZ value has the linear characteristic, the first conversion unit 212 includes a conversion unit 212_{A} which converts the signal level of the color signal Wᵢₙ of the white color into the XYZ value, and a conversion unit 212_{B} which converts the XYZ value into an RGB value on the basis of a known 3×3 conversion matrix.

The second conversion unit 213 converts the signal level of the color signal Wᵢₙ corresponding to the white color into the signal level of the color signals Rᵢₙ, Gᵢₙ, and Bᵢₙ of the other primary colors on the basis of a non-linear characteristic of the gradation-XYZ value which gives the actual chromaticity expressed by the color signals Rᵢₙ, Gᵢₙ, Bᵢₙ, and Wᵢₙ of the four primary colors.

More specifically, assuming that the gradation-XYZ value has the non-linear characteristic, the second conversion unit 213 includes a conversion unit 213_{A} which converts the signal level of the color signal Wᵢₙ of the white color into the XYZ value, and a conversion unit 213_{B} which converts the XYZ value into the RGB value on the basis of the known 3×3 conversion matrix.

The subtraction unit 214 includes subtracters 214_{R}, 214_{G}, and 214_{B} corresponding to the three primary colors and finds, for each primary color, a difference between the signal level converted by the first conversion unit 212 and the signal level converted by the second conversion unit 213.

By the action of the aforementioned first conversion unit 212, second conversion unit 213, and subtraction unit 214, correction signals ΔR, ΔG, and ΔB for the chromaticity of the color signals Rᵢₙ, Gᵢₙ and Bᵢₙ of the other primary colors can be generated as a difference value from the signal level of each color signal corresponding to predetermined chromaticity, on the basis of the signal level of the color signal Wᵢₙ of the white color. Note that the first conversion unit 212 and the second conversion unit 213 can be configured by employing a multiplier and/or an adder.

According to the chromaticity change correction circuit 20_{G} of the sixth embodiment having the aforementioned configuration, the correction signals ΔR, ΔG, and ΔB may be generated as the difference value from the color signal Wᵢₙ corresponding to the chromaticity in the maximum gradation of the white color that is the primary color to be corrected, whereby the correction signals ΔR, ΔG, and ΔB can be generated in a small circuit scale.

Note that while the correction signal generation unit 21 is configured by the hardware including the first conversion unit 212, the second conversion unit 213, and the subtraction unit 214 in the present embodiment, it can also be configured to execute each function of the first conversion unit 212, the second conversion unit 213, and the subtraction unit 214 by software while using a microcomputer.

### 4. Comparative Example

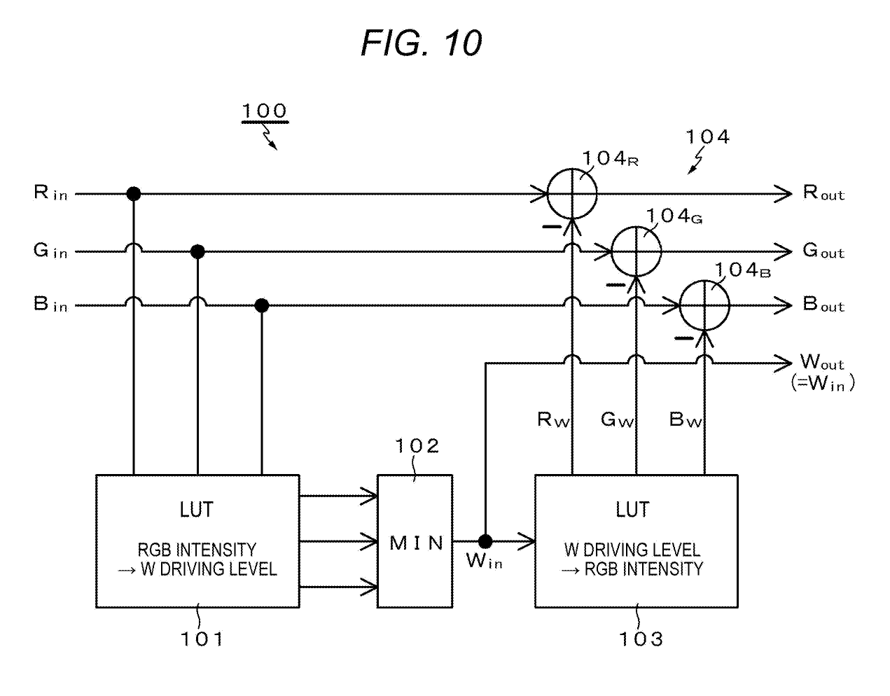

Here, a color signal processing circuit according to the conventional technology described in Patent Document 1 (Published Japanese Translation of PCT Application No. 2010-524044) will be described as a comparative example of the chromaticity change correction circuit 20 according to the embodiments of the present disclosure. FIG. 10 is a block diagram illustrating a configuration of a conventional color signal processing circuit according to the comparative example.

As illustrated in FIG. 10, a color signal processing circuit 100 according to the comparative example (conventional technology) includes a look up table 101, a minimum value selection unit 102, a look up table 103, and a correction unit 104.

The look up table 101 performs processing of converting a signal level (intensity) of color signals Rᵢₙ, Gᵢₙ, and Bᵢₙ corresponding to three primary colors into a white color driving level (signal level). The minimum value selection unit 102 performs processing of selecting a minimum value as a color signal Wᵢₙ of the white color. The look up table 103 performs processing of generating correction signals R_{W}, G_{W}, and B_{W} from the color signal Wᵢₙ of the white color. The correction unit 104 employs subtracters 104_{R}, 104_{G}, and 104_{B} to perform processing of subtracting the correction signals R_{W}, G_{W}, and B_{W} from the signal level of the color signals Rᵢₙ, Gᵢₙ, and Bᵢₙ of the three primary colors.

The conventional color signal processing circuit 100 according to the comparative example having the aforementioned configuration is configured to incorporate a chromaticity change correction circuit in the signal conversion circuit which converts the color signals Rᵢₙ, Gᵢₙ, and Bᵢₙ of the three primary colors into the color signals Rᵢₙ, Gᵢₙ, Bᵢₙ, and Wᵢₙ of the four primary colors. A circuit part formed of the look up table 103 and the correction unit 104 then corresponds to the chromaticity change correction circuit 20 according to the embodiments of the present disclosure.

Now focusing on the correction unit 104, the color signals Rᵢₙ, Gᵢₙ and Bᵢₙ of the three primary colors are directly input to the correction unit 104 where the color signal Wᵢₙ of the white color is added to these color signals Rᵢₙ, Gᵢₙ, and Bᵢₙ, so that the light emission luminance increases by the amount of the color signal Wᵢₙ being added. The correction unit 104 thus performs correction of the luminance in addition to the correction of the chromaticity. The look up table 103 needs to cover the full range of the signal value of each primary color in order to correct the luminance in addition to the chromaticity, and thus has an increased data volume.

In the chromaticity change correction circuit 20 according to the embodiments of the present disclosure, on the other hand, the correction signals ΔR, ΔG, and ΔB may be generated as the difference value from the color signal Wᵢₙ corresponding to the chromaticity in the maximum gradation of the white color, so that the output from the correction signal generation unit 21 need not cover the full range of the signal value of the color signals Rᵢₙ, Gᵢₙ, and Bᵢₙ. As a result, where the bit precision of the output value of the correction signal generation unit 21 is the same as when the full range needs to be covered, there can be reduced the data volume as compared to the case where the full range needs to be covered.

### 5. Variation of Embodiments

While there have been described the preferred embodiments of the present disclosure, the technology pertinent to the present disclosure is not limited to the aforementioned preferred embodiments but can be modified or altered in various ways without departing from the gist of the present disclosure described in claims.

While there has been illustrated the example where the signal conversion circuit 10 having the configuration illustrated in FIG. 2 is provided in the stage preceding the chromaticity change correction circuit 20 in the aforementioned embodiments, the color signals of the three primary colors may be converted into the color signals of the four primary colors by any method, or the signal conversion circuit itself need not be provided.

Moreover, in the aforementioned embodiments, one pixel is formed of the RGBW subpixels where W is the primary color to be corrected and RGB are the primary colors used to correct the chromaticity. This however is merely provided as an example, and thus another combination of colors can be applied among the RGB primary colors and other primary colors. For example, one pixel can be formed of RGB subpixels where one of these primary colors is used as the primary color to be corrected and another primary colors of these primary colors is used as the primary color to correct the chromaticity.

While the aforementioned embodiments correct the change in chromaticity corresponding to the signal level of the color signal of one primary color, the primary color may be used to correct a relative change in chromaticity with respect to the chromaticity in a specific signal level or may be used to correct an absolute change in chromaticity with respect to target chromaticity. Moreover, the two may be combined together for use.

### 6. Electronic Apparatus of Present Disclosure

The display device using the color signal processing circuit of the aforementioned present disclosure, namely the display device of the present disclosure, can be used as a display unit (display device) of an electronic apparatus in every field which includes the display unit displaying a picture signal input to the electronic apparatus or a picture signal generated in the electronic apparatus as an image or a picture.

The electronic apparatus using the display device of the present disclosure as the display unit can be a portable information device such as a digital camera, a video camera, a game machine, a notebook personal computer, a television system, a projection display system and an electronic book device, or a portable communication device such as a mobile phone.

### 7. Configuration of Present Disclosure

The present disclosure can adopt the following configuration.

[1] A color signal processing circuit including: a correction signal generation unit which generates, on the basis of a signal level of a color signal corresponding to one primary color among color signals corresponding to a plurality of primary colors being input, a correction signal for chromaticity of a color signal corresponding to another primary color as a difference value from a signal level of each color signal corresponding to predetermined chromaticity; and a correction unit which uses the correction signal generated by the correction signal generation unit to correct the color signal corresponding to the other primary color.
[2] The color signal processing circuit according to [1] above, wherein luminance expressed by the color signal of the plurality of primary colors being input is identical to luminance expressed by the color signal of the other primary color corrected by the correction unit and the color signal of the one primary color.
[3] The color signal processing circuit according to [1] or [2] above, wherein the correction unit performs processing of adding a correction signal to the color signal of the other primary color.
[4] The color signal processing circuit according to [3] above, wherein the correction signal generation unit generates, for the color signal of the one primary color, a correction signal which corrects an increase in the luminance caused by the addition of the correction signal to the color signal of the other primary color, and the correction unit performs processing of subtracting the correction signal generated by the correction signal generation unit from the signal level of the color signal corresponding to the one primary color.
[5] The color signal processing circuit according to [3] above, wherein the correction signal generation unit outputs the color signal of the one primary color as a signal from which the increase in the luminance caused by the addition of the correction signal to the color signal of the other primary color is subtracted.
[6] The color signal processing circuit according to any of [1] to [6] above, wherein the plurality of primary colors corresponds to four primary colors including red, green, blue, and white colors, and the color signal of the one primary color is a color signal of the white color.
[7] The color signal processing circuit according to [6] above, wherein the color signal of the white color is a signal generated from the color signal of each of the red, green and blue colors which expresses a predetermined gradation.
[8] The color signal processing circuit according to [7] above, wherein the luminance expressed by the color signal of four primary colors that is the color signal of the plurality of primary colors being input is identical to the luminance expressed by the color signal of each of the red, green and blue colors expressing the predetermined gradation.
[9] The color signal processing circuit according to [8] above, wherein the color signal of the plurality of primary colors being input is supplied from a signal conversion circuit which converts the color signal of the three primary colors including the red, green and blue colors expressing the predetermined gradation into the color signal of the four primary colors including the white color on the basis of the color signal of the three primary colors, and the signal conversion circuit sets the luminance expressed by the color signal of the four primary colors after conversion to be identical to the luminance expressed by the color signal of the three primary colors before conversion.
[10] The color signal processing circuit according to any of [1] to [9] above, wherein the correction signal generation unit generates the correction signal in accordance with temporal characteristic degradation of a display panel which is driven by the color signal of the other primary color corrected by the correction unit and the color signal of the one primary color.
[11] The color signal processing circuit according to any of [1] to [9] above, wherein the correction signal generation unit generates the correction signal in accordance with temperature of a display panel which is driven by the color signal of the other primary color corrected by the correction unit and the color signal of the one primary color.
[12] The color signal processing circuit according to any of [1] to [9] above, wherein the correction signal generation unit generates the correction signal in accordance with a coordinate within a plane of a display panel which is driven by the color signal of the other primary color corrected by the correction unit and the color signal of the one primary color.
[13] The color signal processing circuit according to any of [1] to [12] above, wherein the correction signal generation unit is formed of a look up table in which the signal level of the color signal of the one primary color is stored in association with the correction signal for the color signal of the other primary color.
[14] The color signal processing circuit according to [13] above, wherein a plurality of the look up tables is provided in accordance with a change in chromaticity caused by the temporal characteristic degradation of the display panel which is driven by the color signal of the other primary color corrected by the correction unit and the color signal of the one primary color, and one of the look up tables is selected according to a degree of the temporal characteristic degradation of the display panel.
[15] The color signal processing circuit according to [13] above, wherein a plurality of the look up tables is provided in accordance with a change in chromaticity caused by the temperature of the display panel which is driven by the color signal of the other primary color corrected by the correction unit and the color signal of the one primary color, and one of the look up tables is selected according to a detected temperature of the display panel.
[16] The color signal processing circuit according to [13] above, wherein a plurality of the look up tables is provided in accordance with a change in chromaticity within the plane of the display panel which is driven by the color signal of the other primary color corrected by the correction unit and the color signal of the one primary color, and one of the look up tables is selected according to a coordinate within the plane of the display panel.
[17] The color signal processing circuit according to any one of [1] to [12] above, wherein the correction signal generation unit includes: a first conversion function which converts the signal level of the color signal corresponding to the one primary color into the signal level of the color signal corresponding to the other primary color on the basis of a characteristic between a gradation and an XYZ value in an XYZ coordinate system that gives predetermined chromaticity; a second conversion function which converts the signal level of the color signal corresponding to the one primary color into the signal level of the color signal corresponding to the other primary color on the basis of a non-linear characteristic between the gradation and the XYZ value in the XYZ coordinate system that gives actual chromaticity expressed by the color signal of the plurality of primary colors; and a subtraction function which finds a difference between the signal level converted by the first conversion function and the signal level converted by the second conversion function.
[18] A color signal processing method including: generating, on the basis of a signal level of a color signal corresponding to one primary color among color signals corresponding to a plurality of primary colors being input, a correction signal for chromaticity of a color signal corresponding to another primary color as a difference value from a signal level of each color signal corresponding to predetermined chromaticity; and using the generated correction signal to correct the color signal corresponding to the other primary color.
[19] A display device including: a display panel in which a unit pixel including a plurality of subpixels corresponding to a plurality of primary colors is arranged; and a color signal processing circuit which processes a color signal of the plurality of primary colors driving the plurality of subpixels, wherein the color signal processing circuit includes: a correction signal generation unit which generates, on the basis of a signal level of a color signal corresponding to one primary color among color signals corresponding to the plurality of primary colors being input, a correction signal for chromaticity of a color signal corresponding to another primary color as a difference value from a signal level of each color signal corresponding to predetermined chromaticity; and a correction unit which uses the correction signal generated by the correction signal generation unit to correct the color signal corresponding to the other primary color.
[20] An electronic apparatus including a display device which includes: a display panel in which a unit pixel including a plurality of subpixels corresponding to a plurality of primary colors is arranged; and a color signal processing circuit which processes a color signal of the plurality of primary colors driving the plurality of subpixels, wherein the color signal processing circuit includes: a correction signal generation unit which generates, on the basis of a signal level of a color signal corresponding to one primary color among color signals corresponding to the plurality of primary colors being input, a correction signal for chromaticity of a color signal corresponding to another primary color as a difference value from a signal level of each color signal corresponding to predetermined chromaticity; and a correction unit which uses the correction signal generated by the correction signal generation unit to correct the color signal corresponding to the other primary color.

### REFERENCE SIGNS LIST

1 Display device
10 Signal conversion circuit
11 Minimum value selection unit
12_{R}, 12_{G}, 12_{B}, 13_{R}, 13_{G}, 13_{B} Multiplier
14_{R}, 14_{G}, 14_{B} Subtracter
20, 20_{A} to 20_{G} Chromaticity change correction circuit
21 Correction signal generation unit
22, 22_{A}, 22_{B} Correction unit
30 Drive circuit
40 Display panel
50 Control unit
60 Characteristic degradation detection unit
70 Panel temperature detection unit
80 In-plane coordinate detection unit
211_{A} to 211_{D} Look up table (LUT)

1. A color signal processing circuit comprising:
a correction signal generation unit which generates, on the basis of a signal level of a color signal corresponding to one primary color among color signals corresponding to a plurality of primary colors being input, a correction signal for chromaticity of a color signal corresponding to another primary color as a difference value from a signal level of each color signal corresponding to predetermined chromaticity; and
a correction unit which uses the correction signal generated by the correction signal generation unit to correct the color signal corresponding to the other primary color.

2. The color signal processing circuit according to claim 1, wherein luminance expressed by the color signal of the plurality of primary colors being input is identical to luminance expressed by the color signal of the other primary color corrected by the correction unit and the color signal of the one primary color.

3. The color signal processing circuit according to claim 1, wherein the correction unit performs processing of adding a correction signal to the color signal of the other primary color.

4. The color signal processing circuit according to claim 3, wherein
the correction signal generation unit generates, for the color signal of the one primary color, a correction signal which corrects an increase in the luminance caused by the addition of the correction signal to the color signal of the other primary color, and
the correction unit performs processing of subtracting the correction signal generated by the correction signal generation unit from the signal level of the color signal corresponding to the one primary color.

5. The color signal processing circuit according to claim 3, wherein the correction signal generation unit outputs the color signal of the one primary color as a signal from which the increase in the luminance caused by the addition of the correction signal to the color signal of the other primary color is subtracted.

6. The color signal processing circuit according to claim 1, wherein the plurality of primary colors corresponds to four primary colors including red, green, blue, and white colors, and the color signal of the one primary color is a color signal of the white color.

7. The color signal processing circuit according to claim 6, wherein the color signal of the white color is a signal generated from the color signal of each of the red, green and blue colors which expresses a predetermined gradation.

8. The color signal processing circuit according to claim 7, wherein the luminance expressed by the color signal of the four primary colors that is the color signal of the plurality of primary colors being input is identical to the luminance expressed by the color signal of each of the red, green and blue colors expressing the predetermined gradation.

9. The color signal processing circuit according to claim 8, wherein
the color signal of the plurality of primary colors being input is supplied from a signal conversion circuit which converts the color signal of the three primary colors including the red, green and blue colors expressing the predetermined gradation into the color signal of the four primary colors including the white color on the basis of the color signal of the three primary colors, and
the signal conversion circuit sets the luminance expressed by the color signal of the four primary colors after conversion to be identical to the luminance expressed by the color signal of the three primary colors before conversion.

10. The color signal processing circuit according to claim 1, wherein the correction signal generation unit generates the correction signal in accordance with temporal characteristic degradation of a display panel which is driven by the color signal of the other primary color corrected by the correction unit and the color signal of the one primary color.

11. The color signal processing circuit according to claim 1, wherein the correction signal generation unit generates the correction signal in accordance with temperature of a display panel which is driven by the color signal of the other primary color corrected by the correction unit and the color signal of the one primary color.

12. The color signal processing circuit according to claim 1, wherein the correction signal generation unit generates the correction signal in accordance with a coordinate within a plane of a display panel which is driven by the color signal of the other primary color corrected by the correction unit and the color signal of the one primary color.

13. The color signal processing circuit according to claim 1, wherein the correction signal generation unit is formed of a look up table in which the signal level of the color signal of the one primary color is stored in association with the correction signal for the color signal of the other primary color.

14. The color signal processing circuit according to claim 13, wherein a plurality of the look up tables is provided in accordance with a change in chromaticity caused by the temporal characteristic degradation of the display panel which is driven by the color signal of the other primary color corrected by the correction unit and the color signal of the one primary color, and one of the look up tables is selected according to a degree of the temporal characteristic degradation of the display panel.

15. The color signal processing circuit according to claim 13, wherein a plurality of the look up tables is provided in accordance with a change in chromaticity caused by the temperature of the display panel which is driven by the color signal of the other primary color corrected by the correction unit and the color signal of the one primary color, and one of the look up tables is selected according to a detected temperature of the display panel.

16. The color signal processing circuit according to claim 13, wherein a plurality of the look up tables is provided in accordance with a change in chromaticity within the plane of the display panel which is driven by the color signal of the other primary color corrected by the correction unit and the color signal of the one primary color, and one of the look up tables is selected according to a coordinate within the plane of the display panel.

17. The color signal processing circuit according to claim 1, wherein the correction signal generation unit includes:
a first conversion function which converts the signal level of the color signal corresponding to the one primary color into the signal level of the color signal corresponding to the other primary color on the basis of a characteristic between a gradation and an XYZ value in an XYZ coordinate system that gives predetermined chromaticity;
a second conversion function which converts the signal level of the color signal corresponding to the one primary color into the signal level of the color signal corresponding to the other primary color on the basis of a non-linear characteristic between the gradation and the XYZ value in the XYZ coordinate system that gives actual chromaticity expressed by the color signal of the plurality of primary colors; and
a subtraction function which finds a difference between the signal level converted by the first conversion function and the signal level converted by the second conversion function.

18. A color signal processing method comprising:
generating, on the basis of a signal level of a color signal corresponding to one primary color among color signals corresponding to a plurality of primary colors being input, a correction signal for chromaticity of a color signal corresponding to another primary color as a difference value from a signal level of each color signal corresponding to predetermined chromaticity; and
using the generated correction signal to correct the color signal corresponding to the other primary color.

19. A display device comprising:
a display panel in which a unit pixel including a plurality of subpixels corresponding to a plurality of primary colors is arranged; and
a color signal processing circuit which processes a color signal of the plurality of primary colors driving the plurality of subpixels, wherein
the color signal processing circuit includes:
a correction signal generation unit which generates, on the basis of a signal level of a color signal corresponding to one primary color among color signals corresponding to the plurality of primary colors being input, a correction signal for chromaticity of a color signal corresponding to another primary color as a difference value from a signal level of each color signal corresponding to predetermined chromaticity; and
a correction unit which uses the correction signal generated by the correction signal generation unit to correct the color signal corresponding to the other primary color.

20. An electronic apparatus comprising a display device which includes:
a display panel in which a unit pixel including a plurality of subpixels corresponding to a plurality of primary colors is arranged; and
a color signal processing circuit which processes a color signal of the plurality of primary colors driving the plurality of subpixels, wherein
the color signal processing circuit includes:
a correction signal generation unit which generates, on the basis of a signal level of a color signal corresponding to one primary color among color signals corresponding to the plurality of primary colors being input, a correction signal for chromaticity of a color signal corresponding to another primary color as a difference value from a signal level of each color signal corresponding to predetermined chromaticity; and
a correction unit which uses the correction signal generated by the correction signal generation unit to correct the color signal corresponding to the other primary color.
